(19) United States
(12) Patent Application Publication
(10) Pub. No.: US 2026/0307627 A1
(43) Pub. Date: Oct. 8, 2026

(54) WHEEL CHOCKS WITH OPENING BIAS AND LOCKING MECHANISMS

(71) Applicant: Ziamatic LLC, Yardley, PA (US)

(72) Inventors: Michael P. Ziaylek, Yardley, PA (US); Keith R. Creely, Levittown, PA (US); Morgan R. Sobel, Marlton, NJ (US); James Jarozynski, Collingswood, NJ (US)

(21) Appl. No.: 19/641,704

(22) Filed: Apr. 8, 2026

Related U.S. Application Data
(60) Provisional application No. 63/785,592, filed on Apr. 8, 2025.
(60) Provisional application No. 63/807,498, filed on May 16, 2025.

(51) Int. Cl. B60T 3/00

(52) U.S. Cl. CPC B60T 3/00

(57) ABSTRACT

A wheel chock capable of transitioning between stowed and deployed configurations can include a biasing member, such as a spring, that biases the wheel chock toward the deployed configuration. The wheel chock also can include a locking mechanism that retains the wheel chock in the stowed configuration until the locking mechanism is activated to release the wheel chock from the stowed configuration.

### CROSS-REFERENCE TO RELATED APPLICATIONS

This application claims the benefit under 35 U.S.C. 119(e) of U.S. application No. 63/785,592, filed Apr. 8, 2025; and U.S. application No. 63/807,498, filed May 16, 2025. The contents of these applications are incorporated by reference herein in their entireties.

### BACKGROUND

Wheel chocks commonly are used to prevent or discourage unintended movement of motorized vehicles, such as fire engines, when the vehicles are parked. The wheel chock typically is placed on the road surface immediately behind or in front of a tire of the vehicle, and is shaped so that the wheel chock presents an obstacle to rolling movement of the tire over the road surface.

Some types of wheel chocks can be configured to transition between a relatively compact configuration suitable for stowage of the wheel chock in a relatively small volume, and a deployed configuration at which the wheel chock assumes a larger shape makes the wheel chock suitable for preventing or discouraging rolling movement of the vehicle tire.

Wheel chocks for use with large vehicles such as fire engines can be relatively large, heavy, and cumbersome, which can make the retrieval and deployment thereof challenging. For example, such wheel chocks may transition unintentionally between their stowed and deployed configurations as they being retrieved and deployed, presenting a risk that the hands and fingers of the user may be caught between the moving parts of the wheel chock and injured. Also, it may be difficult to quickly transition and secure the wheel chock in its deployed configuration under the exigent circumstances, and the low light and inclement weather conditions commonly experienced by first responders.

### SUMMARY

In one aspect of the disclosed technology, a wheel chock includes a body configured to, when in an upright position on a supporting surface, contact a tire of a motorized vehicle resting on the supporting surface to interfere with movement of the tire along the supporting surface. The wheel chock also includes a support arm having a first end connected to the body so that the support arm is rotatable in relation to the body between a first and a second angular position.

The wheel chock is capable of transitioning between an open configuration at which the support arm is located at the second angular position and a second end of the support arm is spaced from the body by a first distance so that the support arm can brace the body in the upright position, and a closed configuration at which the support arm is located at the first angular position and the second end of the support arm is spaced from the body by a second distance less than the first distance so that the wheel chock has a more compact dimensional footprint in the closed configuration than in the open configuration.

The wheel chock further includes a first biasing member associated with the support arm to bias the support arm toward the second angular position thereby biasing the wheel chock toward the open configuration.

In another aspect of the disclosed technology, the first biasing member is a spring.

In another aspect of the disclosed technology, the first biasing member is a torsion spring.

In another aspect of the disclosed technology, the torsion spring is in angular tension when the support arm is in the first and second angular positions.

In another aspect of the disclosed technology, the wheel chock further includes a cross bar connected to the body and rotatable in relation to the body. The cross bar is configured to engage the support arm at or proximate the second end of the support arm when the support arm is in the second angular position, and the engagement of the cross bar and the support arm maintains the support arm in the second angular position.

In another aspect of the disclosed technology, the wheel chock further includes a locking mechanism configured to retain the support arm in the first angular position and thereby maintain the wheel chock in the closed configuration.

In another aspect of the disclosed technology, the locking mechanism includes a locking bracket, and a first pin engageable with the locking bracket on a selective basis when the support arm is in the first angular position. The engagement of the locking bracket and the first pin restrains the support arm from rotating in relation to the body. The locking bracket is fixed to the body and the first pin is mounted on the support arm. Alternatively, the locking bracket is fixed to the support arm and the first pin is mounted on the body.

In another aspect of the disclosed technology, the first biasing member is mounted on the first pin.

In another aspect of the disclosed technology, the locking bracket is configured to resiliently deflect in response to contact with the first pin as the support arm approaches the second angular position.

In another aspect of the disclosed technology, the first pin is configured to deflect in response to contact with the locking bracket as the support arm approaches the first angular position.

In another aspect of the disclosed technology, the locking mechanism further includes a second biasing member configured to bias the first pin into engagement with the locking bracket when the support arm is in the first angular position.

In another aspect of the disclosed technology, the second biasing member is mounted on the first pin.

In another aspect of the disclosed technology, the second biasing member is a compression spring.

In another aspect of the disclosed technology, the wheel chock further includes a second pin fixed to the body or the support arm, wherein the first biasing member is mounted on the second pin.

In another aspect of the disclosed technology, the locking mechanism includes a catch configured to rotate between a locking position and an opening position. The catch is mounted for rotation on the body, is configured to engage the support arm when the catch is in the locking position and the support arm is in the first angular position thereby locking the wheel chock in the closed configuration, and is disengaged from the support arm when the catch is in the opening position. Alternatively, the catch is mounted for rotation on the support arm, is configured to engage the body when the catch is in the locking position and the support arm is in the first angular position thereby locking the wheel chock in the closed configuration, and is disengaged from the body when the catch is in the opening position.

In another aspect of the disclosed technology, the catch includes a bracket engageable with the body or the support arm, and a lip fixed to and projecting from the bracket.

In another aspect of the disclosed technology, the locking mechanism further includes a disc having an undulating surface and fixed to the body or the support arm, and a handle mounted on the first pin. The handle is positioned to contact the undulating surface of the disc so that the handle and the second biasing member urge the first pin into and out of contact with the locking bracket in response to movement of the handle over the undulating surface of the disc.

In another aspect of the disclosed technology, the locking mechanism includes a lock bar and a latch engageable with the lock bar on a selective basis when the support arm is in the first angular position, the engagement of the latch and the lock bar restraining the support arm from rotating in relation to the body. The lock bar is fixed to the body and the latch is mounted for rotation on the support arm. Alternatively, the lock bar is fixed to the support arm and the latch is mounted for rotation on the body.

In another aspect of the disclosed technology, the latch includes a latch body having two side portions that extend generally parallel to each other, and a rear portion that adjoins and extends generally perpendicular to the side portions so that the latch body has a generally U-shaped configuration. The latch also includes a hook portion that adjoins the side portion of the latch body and is engageable with the lock bar.

In another aspect of the disclosed technology, a wheel chock includes a body configured to, when in an upright position on a supporting surface, contact a tire of a motorized vehicle resting on the supporting surface to interfere with movement of the tire along the supporting surface. The wheel chock also includes a support arm having a first end connected to the body so that the support arm is rotatable in relation to the body between a first and a second angular position.

The wheel chock is capable of transitioning between an open configuration at which the support arm is located at the second angular position and a second end of the support arm is spaced from the body by a first distance so that the support arm can brace the body in the upright position, and a closed configuration at which the support arm is located at the first angular position and the second end of the support arm is spaced from the body by a second distance less than the first distance so that the wheel chock has a more compact dimensional footprint in the closed configuration than in the open configuration.

The wheel chock further includes a locking mechanism configured to retain the support arm in the first angular position and thereby maintain the wheel chock in the closed configuration.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a side view of a wheel chock in an open or deployed configuration of the wheel chock;

FIG. 2 is a side view of the wheel chock shown in FIG. 1, in a closed or stowed configuration of the wheel chock;

FIG. 3 is a perspective view of the wheel chock shown in FIGS. 1 and 2, in the open configuration;

FIG. 4 is a side view of a locking mechanism of the wheel chock shown in FIGS. 1-3, depicting a locking bracket and a locking pin of the locking mechanism in a disengaged state;

FIG. 5 is a side view of the locking mechanism shown in FIG. 4, depicting a release lever and the locking pin of the locking mechanism in an un-deflected state;

FIG. 6 is a side view of the locking mechanism shown in FIGS. 4 and 5, depicting the release lever and locking pin in a deflected state;

FIG. 7 is a perspective view of the locking mechanism shown in FIGS. 4-6, depicting the locking bracket and the locking pin in an engaged state;

FIG. 8 is a side view of the locking mechanism shown in FIGS. 4-7, depicting the locking bracket and the locking pin in the disengaged state and depicting the release lever and the locking pin in the deflected state;

FIG. 9 is a perspective view of the locking mechanism shown in FIGS. 4-8, depicting the release lever and the locking pin in the un-deflected state;

FIG. 10 is a perspective view of a spring of the locking mechanism shown in FIGS. 4-9;

FIG. 11 is a perspective view of an alternative embodiment of the wheel chock shown in FIGS. 1-10, in an open configuration of the wheel chock;

FIG. 12 is a bottom view of the wheel chock shown in FIG. 11, in the open configuration;

FIG. 13 is a perspective view of another alternative embodiment of the wheel chock shown in FIGS. 1-10, depicting a handle and a locking pin of the wheel chock in a deflected state;

FIG. 14 is a perspective view of the wheel chock shown in FIG. 13, depicting the handle and locking pin in an un-deflected state;

FIG. 15 is an exploded view of another alternative embodiment of the wheel chock shown in FIGS. 1-10;

FIG. 16 is a perspective view of the wheel chock shown in FIG. 15, depicting a locking pin and a locking bracket of a locking mechanism of the wheel chock in an engaged state;

FIG. 17 is a top view of another alternative embodiment of the wheel chock shown in FIGS. 1-10, in a closed configuration of the wheel chock and depicting a catch of a locking mechanism of the wheel chock in a locking position;

FIG. 18 is a top view of the wheel chock shown in FIG. 17, in the closed configuration and depicting the catch in an opening position;

FIG. 19 is a cross-sectional view of another alternative embodiment of the wheel chock shown in FIGS. 1-10, in a partially-closed configuration, taken through the line A-A of FIG. 22 and showing a latch of a locking system of the wheel chock in a locking position;

FIG. 20 is a magnified view of the area designated “B” in FIG. 19, depicting the wheel chock in the closed configuration;

FIG. 21 is a perspective view of the locking system and a portion of a support arm of the wheel chock shown in FIGS. 19 and 20, depicting the latch of the locking system in the locking position;

FIG. 22 is a front view of the wheel chock shown in FIGS. 19-21;

FIG. 23 is a side view of a latch of the locking system shown in FIGS. 19-22;

FIG. 24 is a top perspective view of the latch of the locking system shown in FIGS. 19-23; and

FIG. 25 is a side view of the latch shown in FIG. 24.

### DETAILED DESCRIPTION

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

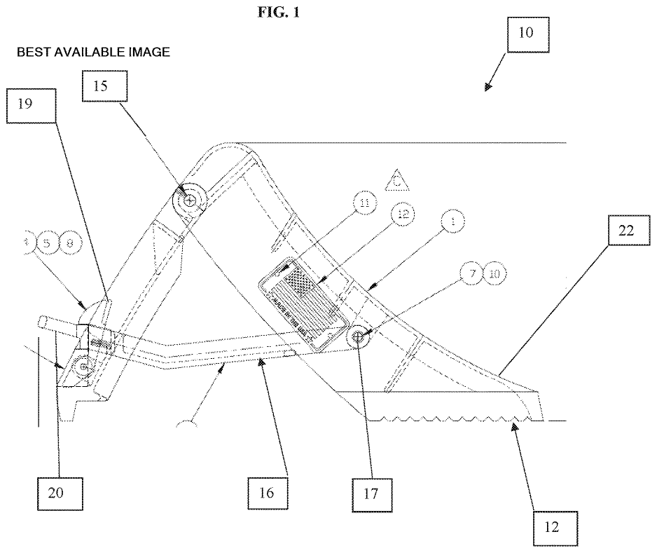

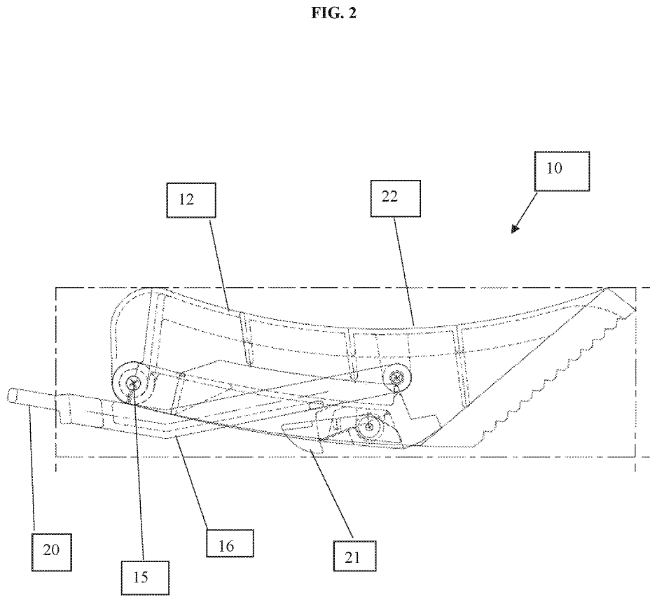

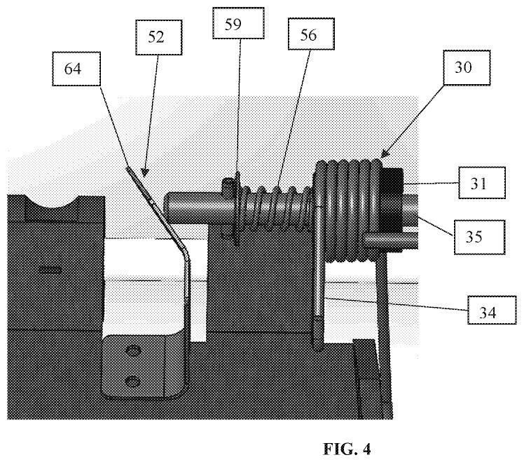

FIGS. 1-10 depict a foldable wheel chock 10. The wheel chock 10 can transition between an open or deployed configuration as shown in FIG. 1, and a stowed or closed configuration shown in FIG. 2. The wheel chock 10, when in the open configuration, can be placed immediately behind or in front of a wheel of a motorized vehicle, such as a fire engine, so that the wheel chock 10 presents an obstacle to rolling movement of the wheel over the supporting surface, i.e., the underlying road surface, thereby preventing or discouraging unintended movement of the vehicle.

Referring to FIGS. 1 and 2, the wheel chock 10 includes a body 12, a rotatable member in the form of a support arm 14, and a cross bar 16. A first end of the support arm 14 is connected to a first end of the body 12 by a pin 15 that permits the support arm 14 to rotate in relation to the body 12 between a first angular position shown in FIG. 2, and a second angular position shown in FIG. 1.

As can be seen in FIG. 1, when the wheel chock 10 is in the open configuration, the support arm 14 is located at the second angular position of the support arm 14 and a second end of the support arm 14 is spaced from the body 12 by a first distance so that the support arm 14 can brace the body 12 in an upright position on a supporting surface such as a roadway surface. As can be seen in FIG. 2, when the wheel chock 10 is in the closed configuration, the support arm 14 is located at the first angular position of the support arm 14 and the second end of the support arm 14 is spaced from the body by a second distance less than the first distance, so that the wheel chock 10 has a more compact dimensional footprint in the closed configuration than in the open configuration.

A first end of the cross bar 16 is connected to the body 12 by a pin 17 that permits the cross bar 16 to rotate in relation to the body 12. The wheel chock 10 further includes a handle 20 fixed to a second end of the cross bar 16. A freestanding second end of the support arm 14 is configured to engage the second end of the cross bar 16 when the wheel chock 10 is in its open configuration. The cross bar 16 is configured to rotate into the body 12 when the wheel chock 10 is transitioned to its closed configuration as shown in FIG. 2. The wheel chock 10 also includes a latch 19 located on the underside of the support arm 14 and visible in FIG. 2. The latch 19 is configured to engage the second end of the cross bar 16 when the wheel chock 10 is in its open configuration, to maintain the second end the of the cross bar 16 in contact with the support arm 14 and thereby maintain the wheel chock 10 in its open configuration until the latch 19 is actuated to release the cross bar 16.

The body 12 has a curved major surface 22. The major surface 22 is configured to contact the tire of the motorized vehicle when the wheel chock 10 is deployed. The reactive force exerted by the wheel chock 10 as the tire pushes against the major surface 22 prevents or discourages rolling movement of the tire across the supporting surface, i.e., across the underlying road surface on which the tire and the wheel chock 10 are resting.

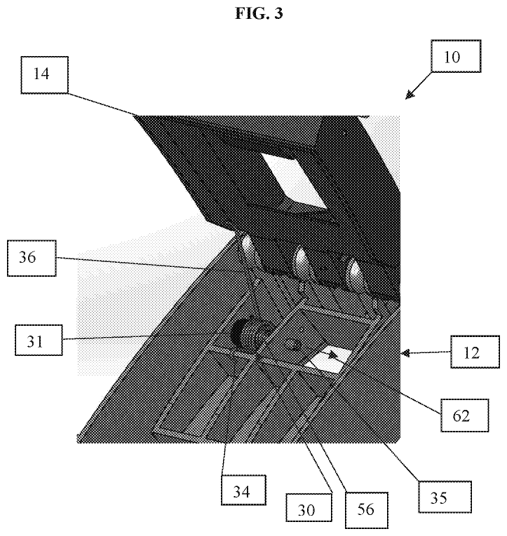

The wheel chock 10 can be locked in its closed or stowed configuration, as discussed below. The wheel chock 10 also includes a biasing member in the form of a spring 30, visible in FIGS. 3-6 and 10. The spring 30 is configured to bias the wheel chock 10 toward its open configuration, causing the wheel chock 10 to open automatically upon being unlocked from its closed configuration. The spring bias also discourages or prevents the wheel chock 10 from slamming closed unintentionally, reducing a potential hazard to users who otherwise could have a hand or fingers inadvertently caught between the moving parts of the wheel chock 10.

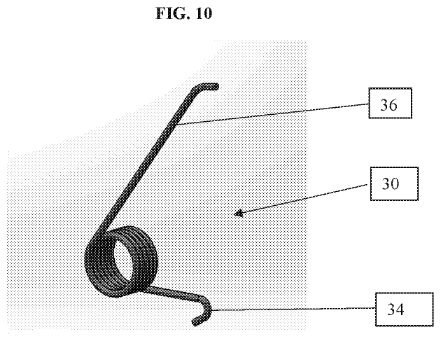

The spring 30 can be configured as a torsion spring. The spring 30 includes a coil 32, a first arm 34 adjoining a first end of the coil 32, and a second arm 36 adjoining a second end of the coil 32 as shown in FIG. 10. The spring 30 is positioned on the underside of the body 12. The spring 30 is mounted on a spacer 31 positioned within the coil 32, as depicted in FIGS. 3-6. The spacer 31 has an outer diameter about equal to an inner diameter of the coil 32. The spacer 31 is mounted on a pin 35 that extends through the spacer 31, and through holes in the sides of the body 12. The spacer 31 can be formed from plastic, and the spring 30 and pin 35 can be formed from stainless steel, to help reduce wear and avoid issues associated with contact between dissimilar metals. The spacer 31, the spring 30, and the pin 35 can be formed from other suitable materials in alternative embodiments.

The first arm 34 of the spring 30 is relatively short and has a curved end portion that engages the body 12, as shown in FIGS. 3-6 and 10. The second arm 36 is relatively long and engages the support arm 14. The freestanding end of the second arm 36 slides along the adjacent surface of the support arm 14 as the support arm 14 rotates in relation to the body 12 as the wheel chock 10 is transitioned between its open and closed configurations. The freestanding end of the second arm 36 is bent away from the support arm 14 as can be seen in FIG. 3, to help prevent gouging of the support arm 14. The relatively long length of the second arm 36 helps to maximize the spring force exerted on the support arm 14 by the spring 30.

The spring angle of the spring 30 is selected to be greater than the angle between the body 12 and the support arm 14 when the wheel chock 10 is in its open configuration. Thus, the spring 30 is pre-loaded when the wheel chock 10 is in its open configuration and always is in angular tension. The opening speed of the wheel chock 10, i.e., the speed at which the support arm 14 rotates away from the body 12 as the wheel chock 10 is opened, can be controlled, in part, based on the selection of the spring angle of the spring 30.

The spring 30 can be formed from 0.162-inch diameter wire, to provide the spring 30 with sufficient strength to facilitate the use of a single spring 30 to open the wheel chock 10. The spring 30 can be formed from wire having diameters greater and less than 0.162 inch in alternative embodiments. Alternative embodiments of the wheel chock 10 can include more than one spring 30 (or other type of biasing member).

Locating the spring 30 on the underside of the body 12 partially isolates and thus protects the spring 30 from the many potentially damaging objects that may commonly interact with the exterior surfaces of the wheel chock 10, such as tires, road surfaces, mud, stones, snow, and ice. Also, locating the spring 30 in the noted manner can help produce a desirable profile in the applied spring force. Specifically, locating the spring 30 in the noted manner results in the application of maximal opening force as the wheel chock 10 begins to open, with the applied spring force reducing continually as the wheel chock 10 opens.

Referring to FIGS. 3-9, the wheel chock 10 also includes a locking mechanism 50. The locking mechanism 50 maintains the wheel chock 10 in its closed configuration. The locking mechanism 50 includes a lock plate 52, a release lever 54, a compression spring 56, and a pin 58. The locking mechanism 50 also includes the pin 35 discussed above in relation to the spring 30.

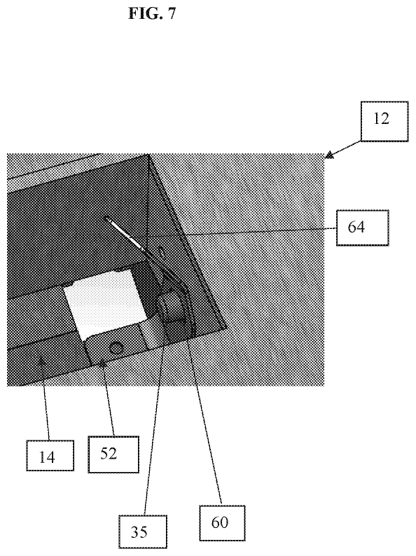

The lock plate 52 is fixed to the support arm 14. The lock plate 52 has a slot 60 formed therein. The slot 60 is positioned to receive an end of the pin 35, as depicted in FIG. 7, when the wheel chock 10 is in its closed configuration. As discussed above, the pin 35 is mounted on the underside of the body 12. The engagement of the pin 35 and the lock plate 52 inhibits the cross bar 16 from rotating in relation to the body 12, thereby causing wheel chock 10 to remain in its closed configuration.

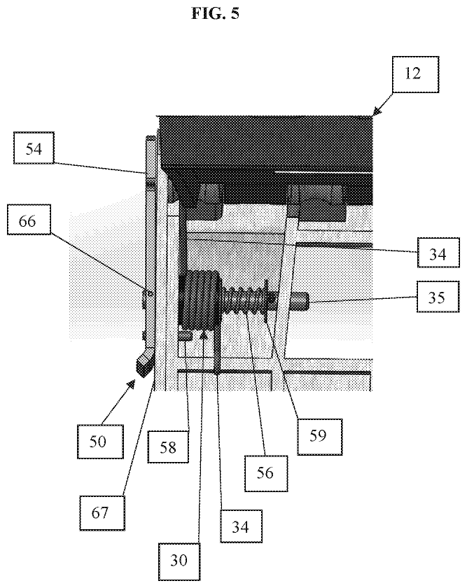

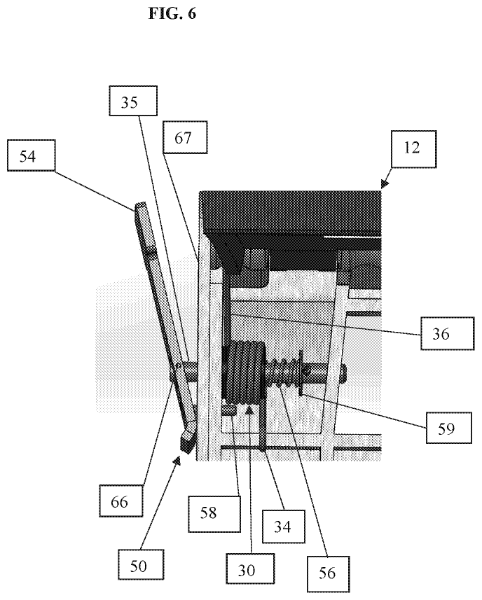

The compression spring 56 is positioned around the pin 35 and inward of the spacer 31, as shown in FIGS. 5 and 6. One end of the spring 56 engages the spacer 31, and the other end engages a sleeve 59 fixed to the pin 35. The spring 56 biases the pin 35 inward, toward the centerline of the body 12, in the direction of the arrow 62 shown in FIG. 3.

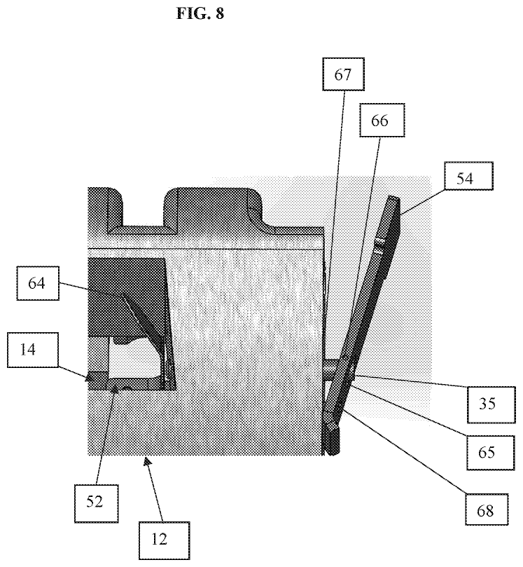

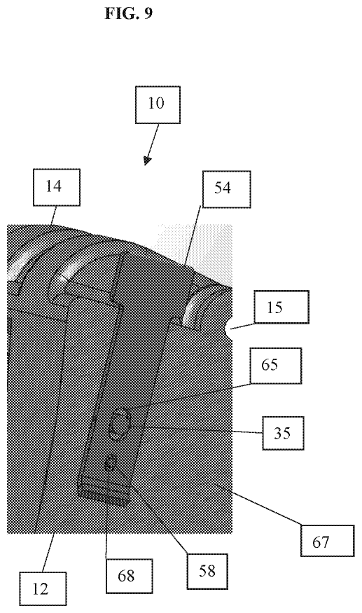

The lock plate 52 has an angled portion 64, visible in FIGS. 8 and 9. The angled portion 64 is configured to engage the inward end of the pin 35 as the support arm 14 rotates toward the body 12 as the wheel chock 10 is closed. The angled orientation of the angled portion 64 causes the pin 35 to move outward, as the pin 35 slides along the angled portion 64. The continued movement of the pin 35 along the angled portion 64 eventually results in alignment of the pin 35 with the slot 60 as the wheel chock 10 reaches its closed configuration, at which point the inward end of the pin 35 enters the slot 60 due to the inward bias of the spring 56 on the pin 35. The resulting engagement of the pin 35 and lock plate 52 locks the wheel chock 10 in its closed configuration as discussed above, with the spring 56 helping to retain the pin 35 in the slot 60.

The release lever 54 facilitates disengagement of the pin 35 from the lock plate 52 by the user, so that the wheel chock 10 can be moved to its open or deployed configuration. The release lever 54 is disposed on an outward-facing side surface 67 of the body 12, as shown in FIG. 9. The release lever 54 has a slot 65 formed therein. The slot 65 receives an outward end of the pin 35, which also extends through an underlying slot or hole (not shown) in the side of the body 12. The release lever 54 is coupled to the outward end of the pin 35 by a pin 66 that facilitates rotation of the release lever 54 in relation to the pin 35, as depicted in FIGS. 6 and 8. The release lever 54 has another slot 68 formed therein, proximate a lower end of the release lever 54 as shown in FIG. 9. The slot 68 receives the pin 58, which is fixed the underlying side of the body. The engagement of the pin 58 and the release lever 54, in combination with the engagement of the pin 35 and the release lever 54, prevents the release lever 54 from rotating in relation to the body 12 and thus maintains the release lever 54 in proper alignment with the body 12.

The inward bias of the pin 35 caused by the spring 56 urges the release lever 54, which is connected to the pin 35 via the pin 66, against the underlying side surface 67 of the body 12. The user can unlock the wheel chock 10 to deploy the wheel chock 10 to its open configuration by pulling the upper end of the release lever 54 outward, away from the body 12 as shown in FIGS. 6 and 8, against the bias of the spring 56, so that the release lever 54 rotates or tilts in relation to the side surface 67 of the body 12 with the bottom the release lever 54 remaining in contact with the side surface 67. This action causes the inward end of the pin 35 to withdraw from the slot 60 in the lock plate 52, at which point the support arm 14 no longer is restricted from rotating in relation to the body 12, allowing the wheel chock 10 to move to its open configuration due to the bias of the spring 30.

The upper portion of the release lever 54 is relatively wide in relation to its lower portion, which can make it easier for the user to engage and pull the release lever 54. Also, the lower end of the release lever 54 is rounded, as shown in FIGS. 6 and 8, to facilitate the tilting of the release lever 54 in relation to the body 12. As can be seen in FIG. 9, the upper end of the release lever 54 does not extend substantially above the adjacent portions of the body 12 and the support arm 14 when the wheel chock 10 is in the closed configuration. Also, the overall configuration of the locking mechanism 50 is low profile and does not substantially increase the overall width of the wheel chock 10.

In alternative embodiments of the wheel chock 10, the torsion spring 30, the spacer 31, the pin 35, the compression spring 56, and the release lever 54 can be mounted on the support arm 14, and the lock plate 52 can be mounted on the body 12.

Alternative embodiments of the wheel chock 10 can be configured with the locking mechanism 50, but without a biasing member such as the spring 30.

The above description of the wheel chock 10 applies equally to the following discussion of various alternative embodiments of the wheel chock 10 unless otherwise noted. Identical reference numerals are used to denote components in the alternative embodiments that are substantially identical to those of the wheel chock 10.

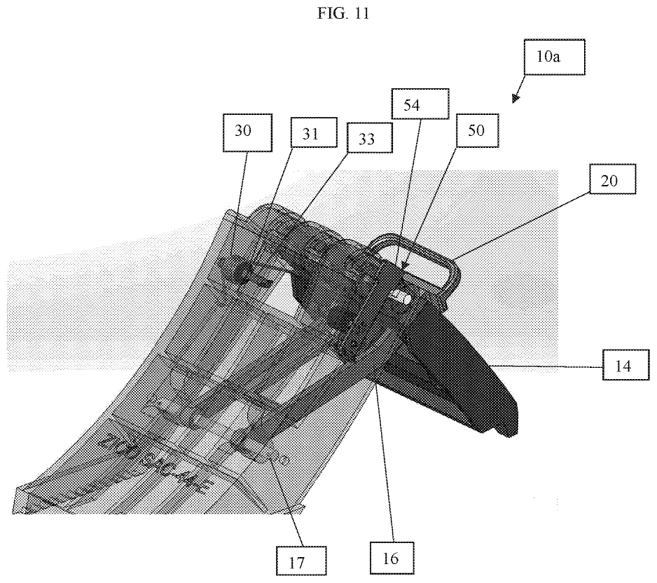

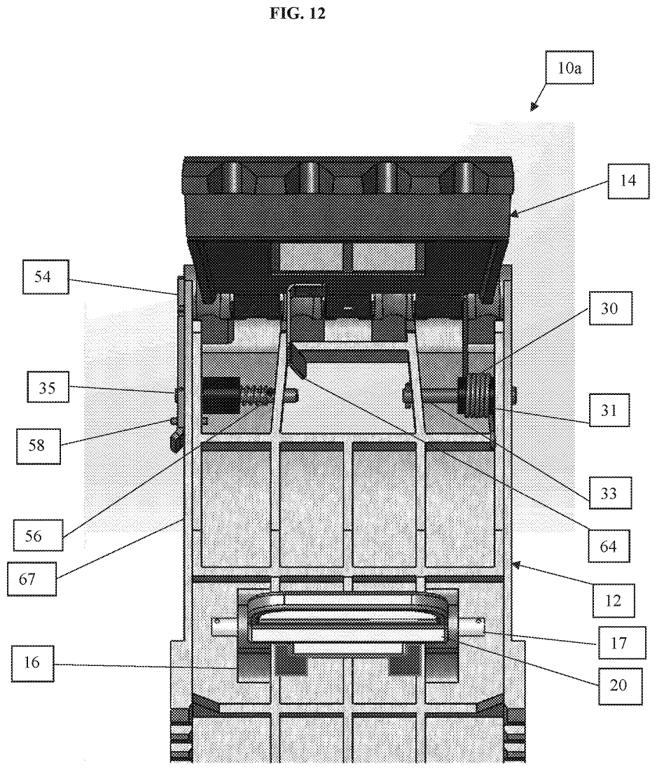

FIGS. 11 and 12 depict an alternative embodiment of the wheel chock 10 in the form of a wheel chock 10a. The wheel chock 10a is substantially identical to the wheel chock 10 with the exception that in the wheel chock 10a, the locking mechanism 50 (including the pin 35) is positioned on an opposite side of the body 12 from the spring 30 and the spacer 31, with the spring 30 and the spacer 31 being mounted on an additional pin 33 fixed to the body 12. This configuration can reduce the potential for the pin 35 to be subjected to excess friction resulting from the force of the spring 30, and may permit the pin 35 to slide more freely than otherwise would be possible.

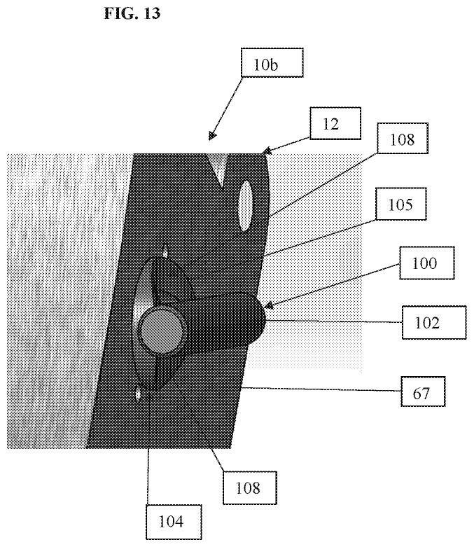

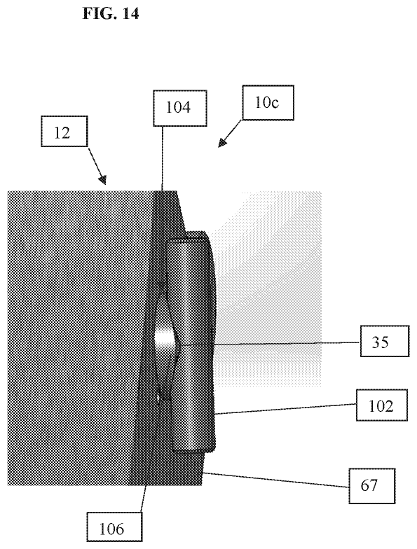

FIGS. 13 and 14 depict another alternative embodiment of the wheel chock 10 in the form of a wheel chock 10b. The wheel chock 10b includes a locking mechanism 100 that is substantially identical to the locking mechanism 50, with the following exceptions.

The locking mechanism 100 includes a cylindrical handle 102 in lieu of the release lever 54 of the locking mechanism 50. The locking mechanism 100 also includes a disc 104 fixed to the side surface 67 of the body 12. The handle 102 is fixed to the outward end of the pin 35, so that the handle 102 and the pin 35 have a generally T-shaped configuration.

An outward-facing, or outer surface 105 of the disc 104 has curvilinear undulations that cause the outer surface 105 to act as a camming surface. In particular, the undulating outer surface 105 defines high portions or peaks 106, and low portions or valleys 108 on the disc 104. The inward bias of the spring 56 on the pin 35 urges the handle 102 against the outer surface 105. The undulations in the outer surface 105 cause the position of the pin 35 in relation to the body 12 to vary as the pin 35 is rotated. In particular, the pin 35 is drawn inwardly and is urged outwardly as the handle 102 travels over the respective valleys 108 and peaks 106 defined in the disc 104.

The disc 104 is configured so that the inward end of the pin 35 is positioned to engage the lock plate 52 via the slot 60 in the lock plate 52 when the handle 102 is located in the valleys 108 defined in the disc 104, as depicted in FIG. 13. The wheel chock 10 thus is locked in its closed configuration as described above in relation to the locking mechanism 50, when the handle 102 is located at a clock position that causes the handle 102 to reside in the valleys 108.

The disc 104 is further configured so that the inward end of the pin 35 moves outward, out of the slot 60 in the lock plate 52, when the handle 102 moves to a clock position that causes the handle 102 to reside on the peaks 106 defined by the outer surface 105 of the disc 104 as depicted in FIG. 14. The wheel chock 10a thus is unlocked and can move to its open configuration as described above in relation to the locking mechanism 50, when the handle 102 is located at a clock position that causes the handle 102 to reside on the peaks 106. The wheel chock 10a thus can be unlocked by rotating or twisting the handle 102 by 180 degrees, with the shape of the disc 104 achieving the desired amount of engagement and disengagement of the pin 35 and the lock plate 52 to unlock the wheel chock 10 from its closed position. The wheel chock 10a can be re-locked once the handle 102 is returned to a clock position that causes it to reside in the valleys 108.

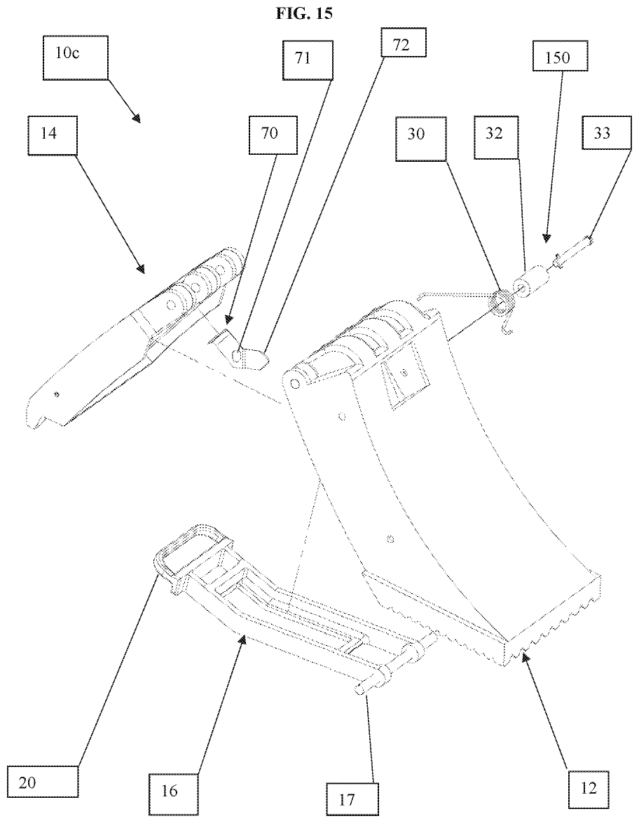

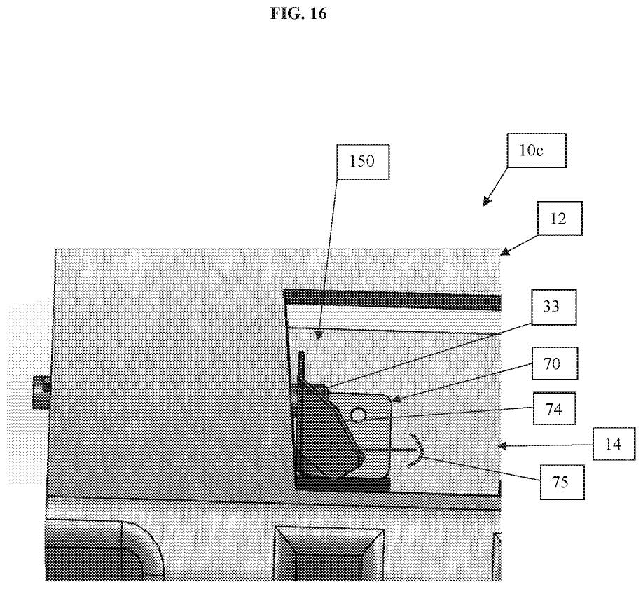

FIGS. 15 and 16 depict another alternative embodiment of the wheel chock 10 in the form of a wheel chock 10c. The wheel chock 10c includes a locking mechanism 150 that is substantially identical to the locking mechanism 50, with the following exceptions.

The locking mechanism 150 includes a stationary pin 33 fixed to the body 12 as discussed above in relation to the wheel chock 10a. A torsion spring and a plastic spacer, such as the spring 30 and the spacer 31, are disposed on the pin 33 so that the spring 30 biases the wheel chock 10c toward its open configuration as discussed above in relation to the wheel chock 10.

The locking mechanism 150 also includes a formed flat spring lock plate 70 fixed to the support arm 14. The lock plate 70 has a slot 71 formed therein. The lock plate 70 is configured so that the slot 71 receives the inward end of the pin 33 when the wheel chock 10c is in its closed configuration, as shown in FIG. 16. The resulting engagement of the pin 33 and the lock plate 70 prevents rotation of the support arm 14 in relation to the body 12, thereby locking the wheel chock 10c in its closed configuration.

The lock plate 70 can be made from 301/302 stainless steel with a full hard or spring hard temper. In alternative embodiments, the lock plate 70 can be made from 17-4 stainless steel and can be heat treated to provide the lock plate 70 with spring characteristics. The lock plate 70 can be formed from other materials in other alternative embodiments.

The lock plate 70 has an angled portion 72. The user can unlock the wheel chock 10c by manually contacting the angled portion 72 and urging the angled portion 72 inward, in the direction denoted by the arrow 75 in FIG. 16. The flexibility of the lock plate 70 allows the angled portion 72 and the adjacent portion of the lock plate 70 to flex and move inward, so that the inward end of the pin 33 exits the slot 71 in the lock plate 70. At this point, the wheel chock 10c is unlocked and the bias of the spring 30 will cause the wheel chock 10c to move from its closed to its open configuration.

The wheel chock 10c automatically locks as the wheel chock 10c is returned to its closed configuration. In particular, the inward end of the pin 33 contacts the angled portion 72 of the lock plate 70 as the wheel chock 10c nears its closed configuration. The angled orientation of the angled portion 72 causes the angled portion 72 and the adjacent portion of the lock plate 70 to move inward as the lock plate 70 flexes in response to the continued movement of the pin 33 along the angled portion 72. The pin 33 reaches the slot in the lock plate 70 as the wheel chock 10c reaches its closed configuration, at which point the angled portion 72 and the adjacent portion of the lock plate 70 will spring outward and return to their undeflected positions shown in FIG. 16 due to the resilience of the lock plate 70, causing the pin 33 to enter the slot 71 and locking the wheel chock 10c in its closed configuration.

The lock plate 70 is configured so that the lock plate 70 does not protrude from the wheel chock 10c, reducing the potential for the lock plate 70 to be damaged, while still providing enough space for a gloved operator to access the lock plate 70 to unlock the wheel chock 10c.

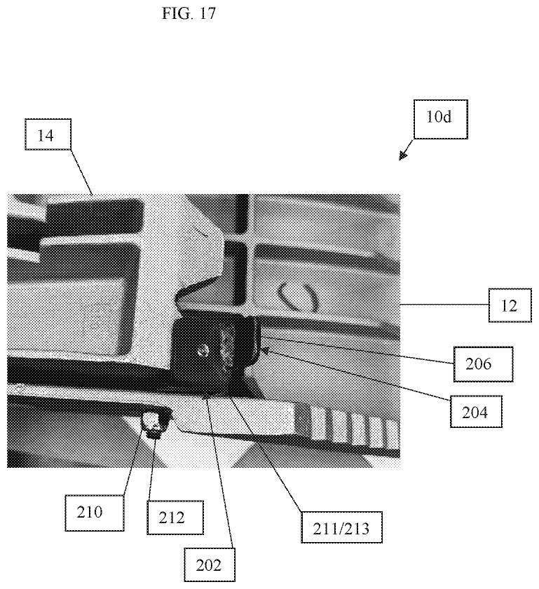

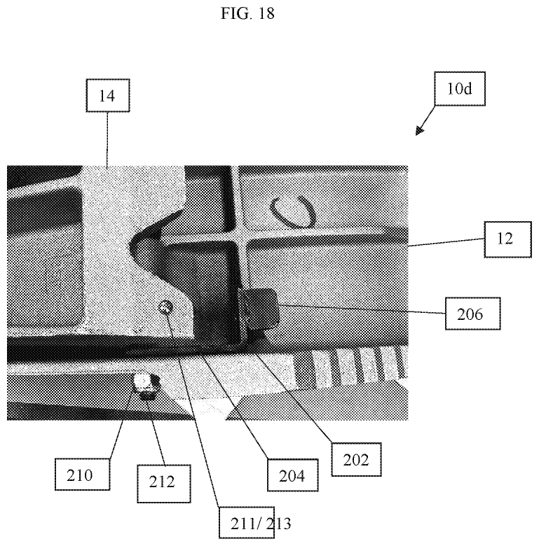

FIGS. 17 and 18 depict another alternative embodiment of the wheel chock 10 in the form of a wheel chock 10d. The wheel chock 10d includes a locking mechanism 200. The locking mechanism 200 includes a catch 202. The catch 202 includes an L-shaped bracket 204 and a lip 206 that adjoins the bracket 204. The catch 202 is mounted on the body 12 so that the catch 202 can rotate or swivel in relation to the body between a locking position shown in FIG. 17, and an opening position shown in FIG. 18. The catch 202 can include a threaded shaft 210 that is fixed to the bracket 204, extends through a hole in the body 12, and is secured to the body 12 using a lock nut 212. The catch 202 can be mounted on the body 12 in other ways in alternative embodiments.

The L-shaped bracket 204 of the catch 202 is configured to engage an edge of the support arm 14 when the wheel chock 10d is in its closed configuration and the catch 202 is in its locking position, as depicted in FIG. 17. The engagement of the catch 202 and the support arm 14 prevents the support arm 14 from rotating away from the body 12, thereby locking the wheel chock 10d in its closed configuration.

The locking mechanism 200 also includes a drive screw or pin 211 fixed to the support arm 14. The L-shaped bracket 204 has a hole 213 formed therein and configured to receive the drive screw or pin 211 when the catch 202 is in its locking position, as shown in FIG. 17. The engagement of the bracket 204 and the drive screw or pin 211 locks the catch 202 in its locking position. Alternative embodiments of the locking mechanism 200 can be configured without this feature.

The wheel chock 10d can be unlocked quickly by the user by exerting force manually against the lip 206 of the catch 202 to rotate the catch 202 to its opening position depicted in FIG. 18. In some applications, the catch 202 can be configured so that the lip 206 snags or catches a fixed opening feature in a storage area in which the wheel chock 10d is stowed, so that the catch 202 is rotated automatically to its opening position and the wheel chock 10d thus unlocks as the user draws the wheel chock 10d from the storage area. For example, a storage bay in a fire engine in which the wheel chock 10d is stowed can be equipped with a protruding fixed feature that is sized and positioned to engage the lip 206 of the catch 202 as the wheel chock 10d is removed from the storage bay, so that the wheel chock 10d automatically unlocks and will assume its open configuration when removed from the storage bay. This feature makes it unnecessary for the user to manually unlock the wheel chock 10d after it has been removed from the storage area, helping to expedite the deployment of the wheel chock 10d.

In alternative embodiments of the locking mechanism 200, the catch 202 can be mounted on the support arm 14 and the drive screw or pin 211 can fixed to the body 12.

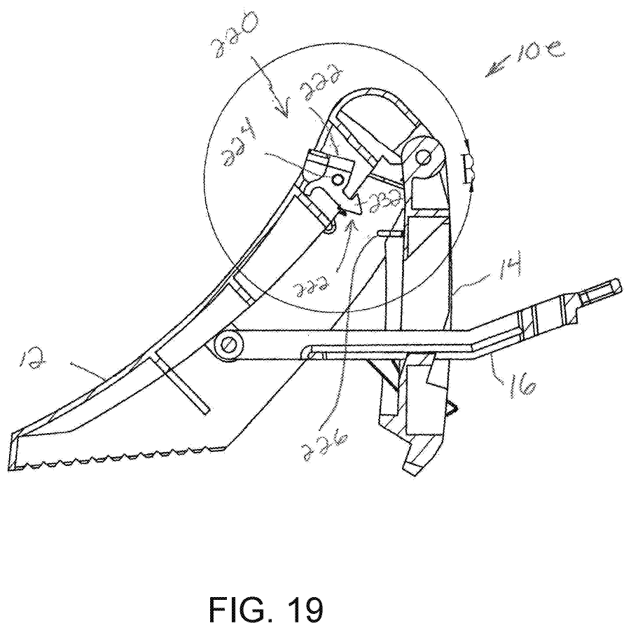

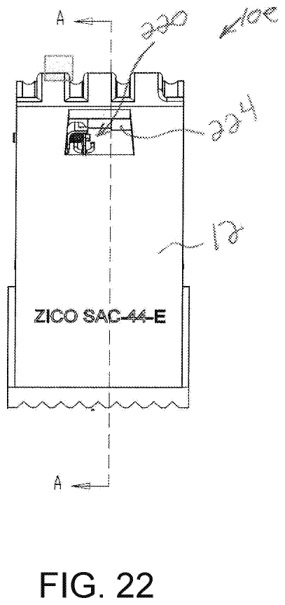

FIGS. 19-25 depict another alternative embodiment of the wheel chock 10 in the form of a wheel chock 10e. The wheel chock 10e is substantially identical to the wheel chock 10 with the exception that the wheel chock 10e includes a locking mechanism 220 in lieu of the lock plate 70. The locking mechanism 220 includes a restraint in the form of a latch 222, a pin 224, another restraint in the form of a lock bar 226, and a spring 228.

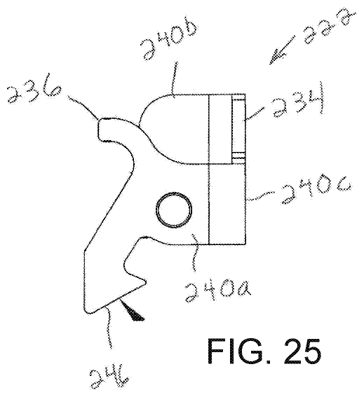

Referring to FIGS. 24 and 25, the latch 222 includes a latch body 230. The latch body 230 has two side portions 240a, 240b that extend generally parallel to each other, and a rear portion 240c that adjoins and extends generally perpendicular to the side portions 240a, 240b, giving the latch body 230 a generally U-shaped configuration.

The latch 222 also includes a hook portion 232 that adjoins the side portion 240a of the latch body 230, and a tab 234 that adjoins the side portion 240b and the rear portion 240c of the latch body 230. The latch 222 also includes a stop 236 that adjoins the side portion 240a of the latch body 230.

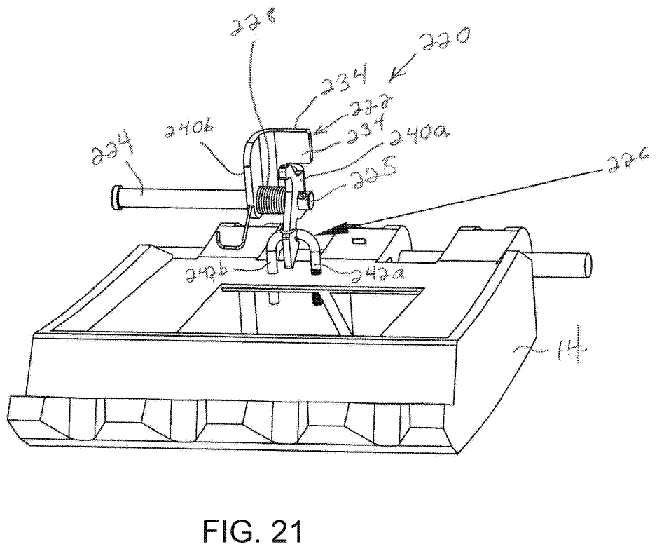

The pin 224 is secured to the body 12 of the wheel chock 10e. The latch 222 is mounted on the pin 224 and is retained on the pin 224 by a retaining pin 225 disposed in a hole formed in the pin 224 as shown in FIG. 21. The latch 222 can be retained on the pin 224 using other suitable techniques in alternative embodiments. The pin 224 extends through respective holes in the side portions 240a, 240b of the latch body 230 with minimal clearance, so that the latch 222 can rotate on the pin 224 and in relation to the body 12.

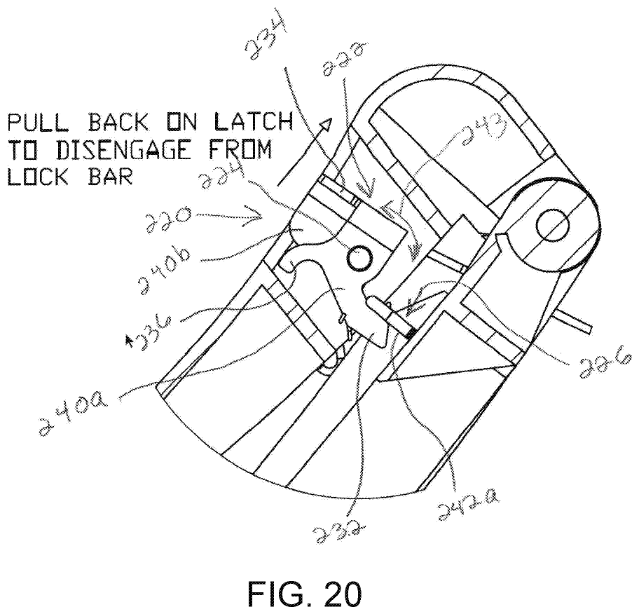

The spring 228 is a torsion spring. The coils of the spring 228 are positioned around the pin 224, and between the side portions 240a, 240b of the latch 222 as shown in FIG. 21. One end of the spring 228 is configured to engage the hook portion 232 of the latch 222, and the other end is configured to engage the body 12. The spring 228 biases the latch 222 in the counterclockwise direction from the perspective of FIGS. 19 and 20, toward a locking position of the spring 228 shown in FIG. 20.

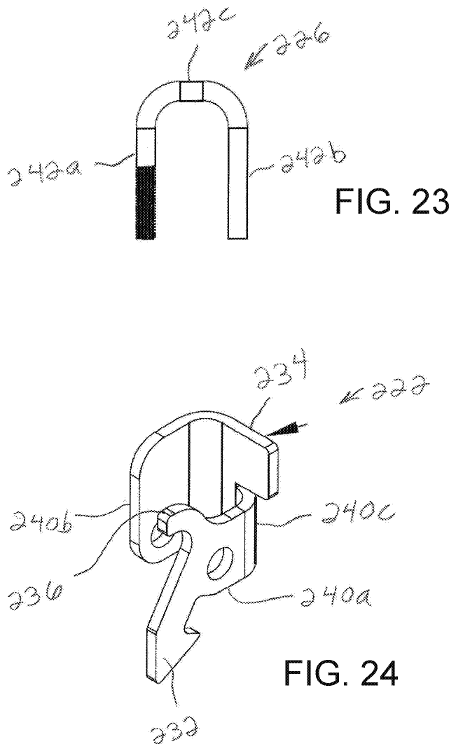

The lock bar 226 is fixed to the support arm 14 of the wheel chock 10e as shown in FIGS. 19-21. Referring to FIG. 23, the lock bar 226 includes a leg 242a, a leg 242b, and a cross member 242c and adjoins the legs 242a, 242b. The legs 242a, 242b are generally parallel, giving the lock bar 226 a generally U-shaped configuration. The leg 242a has threads formed on a lower portion thereof. The threads are configured to engage corresponding threads formed in a threaded hole the support arm 14, to secure the lock bar 226 to the support arm 14 as shown in FIG. 21. The leg 242b extends through a non-threaded hole formed in the body 12. The leg 242a and the leg 242b cooperate to prevent the lock bar 226 from rotating in relation to the support arm 14. The threaded configuration of the leg 242a permits the position of the lock bar 226 to be adjusted in relation to the support arm 14.

The latch 222 is configured so that the hook portion 232 of the latch 222 engages the cross member 242c of the lock bar 226 when the latch 222 is in its locking position and the wheel chock 10e is in its closed configuration, as shown in FIG. 20. The bias of the spring 228 causes the latch 222 to remain in its locking position when engaged with the leg 242c. The engagement of the hook portion 232 and the leg 242c holds the wheel chock 10e in its closed configuration, against the bias of the spring 30 of the wheel chock 10e. The above-noted adjustability of the position of the lock bar 226 in relation to the support arm 14 allows the position of the leg 242c to be adjusted to help ensure proper engagement of the leg 242c and the hook portion 232 when the latch 222 is in its locking position and the wheel chock 10 is in its closed position.

The latch 222 can move from its locking position to an opening position by pulling or pressing the tab 234 of the latch 222 so as to rotate the latch 222 in the clockwise direction, from the perspective of FIGS. 19 and 20. (The rotation of the latch 222 is denoted in FIG. 20 by the arrow 243.) The resulting disengagement of the hook portion 232 of the latch 222 from the leg 242c of the lock bar 226 allows the wheel chock 10c to move from its closed configuration to its open configuration in response to the bias of the spring 30. The latch 222 will return to an angular position at or near its locking position once the manual force is removed from the latch 222. The stop 236 is configured to abut an adjacent surface of the body 12 as shown in FIG. 19, to prevent substantial over-rotation of the latch 222 past its locking position when the wheel chock 10e is in its open configuration.

An angled contact surface 246 of the hook portion 232 of the latch 222 is configured to slide along the leg 242c of the lock bar 226 as the wheel chock 10e is returned to its closed configuration. The contact between the hook portion 232 and the leg 242c causes the latch 222 to rotate slightly away from its locking position, against the bias of the spring 228, until the angled surface 246 moves past the leg 242c, at which point the bias of the spring 228 will cause the latch 222 to return to its locking position in engagement with the leg 242c.

In alternative embodiments, the lock bar 226 can be fixed to the body 12; and the latch 222, the pin 224, and the spring 228 can be mounted on the support arm 14.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A wheel chock, comprising:
a body configured to, when in an upright position on a supporting surface, contact a tire of a motorized vehicle resting on the supporting surface to interfere with movement of the tire along the supporting surface;
a support arm having a first end connected to the body so that the support arm is rotatable in relation to the body between a first and a second angular position, wherein the wheel chock is capable of transitioning between:
an open configuration at which the support arm is located at the second angular position and a second end of the support arm is spaced from the body by a first distance so that the support arm can brace the body in the upright position, and
a closed configuration at which the support arm is located at the first angular position and the second end of the support arm is spaced from the body by a second distance less than the first distance so that the wheel chock has a more compact dimensional footprint in the closed configuration than in the open configuration; and
a first biasing member associated with the support arm to bias the support arm toward the second angular position thereby biasing the wheel chock toward the open configuration.

2. The wheel chock of claim 1, wherein the first biasing member is a spring.

3. The wheel chock of claim 2, wherein the first biasing member is a torsion spring.

4. The wheel chock of claim 3, wherein the torsion spring is in angular tension when the support arm is in the first and second angular positions.

5. The wheel chock of claim 1, further comprising a cross bar connected to the body and rotatable in relation to the body, wherein:
the cross bar is configured to engage the support arm at or proximate the second end of the support arm when the support arm is in the second angular position, and
the engagement of the cross bar and the support arm maintains the support arm in the second angular position.

6. The wheel chock of claim 1, further including a locking mechanism configured to retain the support arm in the first angular position and thereby maintain the wheel chock in the closed configuration.

7. The wheel chock of claim 6,
wherein the locking mechanism includes a locking bracket, and a first pin engageable with the locking bracket on a selective basis when the support arm is in the first angular position, the engagement of the locking bracket and the first pin restraining the support arm from rotating in relation to the body; and
wherein:
the locking bracket is fixed to the body and the first pin is mounted on the support arm; or
the locking bracket is fixed to the support arm and the first pin is mounted on the body.

8. The wheel chock of claim 7, wherein the first biasing member is mounted on the first pin.

9. The wheel chock of claim 7, wherein the locking bracket is configured to resiliently deflect in response to contact with the first pin as the support arm approaches the second angular position.

10. The wheel chock of claim 8, wherein the first pin is configured to deflect in response to contact with the locking bracket as the support arm approaches the first angular position.

11. The wheel chock of claim 10, wherein the locking mechanism further includes a second biasing member configured to bias the first pin into engagement with the locking bracket when the support arm is in the first angular position.

12. The wheel chock of claim 11, wherein the second biasing member is mounted on the first pin.

13. The wheel chock of claim 11, wherein the second biasing member is a compression spring.

14. The wheel chock of claim 7, further including a second pin fixed to the body or the support arm, wherein the first biasing member is mounted on the second pin.

15. The wheel chock of claim 6,
wherein the locking mechanism includes a catch configured to rotate between a locking position and an opening position; and
wherein:
the catch is mounted for rotation on the body, is configured to engage the support arm when the catch is in the locking position and the support arm is in the first angular position thereby locking the wheel chock in the closed configuration, and is disengaged from the support arm when the catch is in the opening position, or
the catch is mounted for rotation on the support arm, is configured to engage the body when the catch is in the locking position and the support arm is in the first angular position thereby locking the wheel chock in the closed configuration, and is disengaged from the body when the catch is in the opening position.

16. The wheel chock of claim 15, wherein the catch includes a bracket engageable with the body or the support arm, and a lip fixed to and projecting from the bracket.

17. The wheel chock of claim 11, wherein:
the locking mechanism further includes:
a disc having an undulating surface and fixed to the body or the support arm, and
a handle mounted on the first pin; and
the handle is positioned to contact the undulating surface of the disc so that the handle and the second biasing member urge the first pin into and out of contact with the locking bracket in response to movement of the handle over the undulating surface of the disc.

18. The wheel chock of claim 6,
wherein the locking mechanism includes a lock bar and a latch engageable with the lock bar on a selective basis when the support arm is in the first angular position, the engagement of the latch and the lock bar restraining the support arm from rotating in relation to the body; and
wherein:
the lock bar is fixed to the body and the latch is mounted for rotation on the support arm; or
the lock bar is fixed to the support arm and the latch is mounted for rotation on the body.

19. The wheel chock of claim 18, wherein the latch includes:
a latch body having two side portions that extend generally parallel to each other, and a rear portion that adjoins and extends generally perpendicular to the side portions so that the latch body has a generally U-shaped configuration; and
a hook portion that adjoins the side portion of the latch body and is engageable with the lock bar.

20. A wheel chock, comprising:
a body configured to, when in an upright position on a supporting surface, contact a tire of a motorized vehicle resting on the supporting surface to interfere with movement of the tire along the supporting surface;
a support arm having a first end connected to the body so that the support arm is rotatable in relation to the body between a first and a second angular position, wherein the wheel chock is capable of transitioning between:
an open configuration at which the support arm is located at the second angular position and a second end of the support arm is spaced from the body by a first distance so that the support arm can brace the body in the upright position, and
a closed configuration at which the support arm is located at the first angular position and the second end of the support arm is spaced from the body by a second distance less than the first distance so that the wheel chock has a more compact dimensional footprint in the closed configuration than in the open configuration; and
a locking mechanism configured to retain the support arm in the first angular position and thereby maintain the wheel chock in the closed configuration.
